(19) United States
(12) Patent Application Publication
(10) Pub. No.: US 2025/0162717 A1
(43) Pub. Date: May 22, 2025

(54) A SEAT PAN FOR AN AIRCRAFT SEAT

(71) Applicant: Safran Seats GB Limited, Cwmbran (GB)

(72) Inventors: Kudzai Mutasa, Cwmbran (GB); Huw Jones, Cwmbran (GB); Richard Harris, Cwmbran (GB); Daniel Morfey, Cwmbran (GB)

(21) Appl. No.: 18/841,270

(22) PCT Filed: Mar. 22, 2023
(86) PCT No.: PCT/GB2023/050725

§ 371 Date: Aug. 23, 2024

(30) Foreign Application Priority Data
Apr. 4, 2022 (GB) 2204918.3

(51) Int. Cl. B64D 11/06

(52) U.S. Cl. CPC B64D 11/0619

(57) ABSTRACT

A seat pan for an aircraft seat. The seat pan is arranged to be fixed to an aircraft seat base, and to support a seat cushion of the aircraft seat. The seat pan includes a corrugated portion formed of a deformable material. The corrugated portion includes a plurality of corrugations.

### TECHNICAL FIELD OF THE INVENTION

The present invention concerns a seat pan for an aircraft seat. More particularly, but not exclusively, the invention concerns a seat pan comprising a corrugated portion formed of a deformable material. The invention also concerns aircraft seats comprising seat pans.

### BACKGROUND OF THE INVENTION

Commercial aircraft seating requires a broad range of structural conditions to be met in order to fulfil regulatory requirements. Rigorous structural tests are defined that must be met in order to ensure passenger safety and seat reliability. The Federal Aviation Administration (FAA) regulation CS/CFR 25.562 (Certification Specifications for Emergency Landing Dynamic Conditions) outlines how two dynamic seat tests and an evaluation of associated pass/fail criteria are required for aircraft seat certification. One of those tests is a combined vertical/longitudinal impact condition that measures, amongst other things, the lumbar-column pelvic load in the Part 572 Subpart E Hybrid III anthropomorphic test dummy (ATD) modified according to SAE 1999-01-1609. This maximum lumbar-column pelvic compressive load must not exceed a 1500 pound-force pass/fail criterion. The test itself is representative of a typical aircraft crash event such that the compressive load will be a result of the combined vertical/longitudinal environment during a crash event.

It would be advantageous to be able to reduce the lumbar-column pelvic compressive load experienced with aircraft seating under vertical/longitudinal impact conditions, in particular without requiring significant modifications to the aircraft seating that have additional engineering cost and potential weight penalties.

U.S. Pat. No. 6,561,580 B1 (Bergey, Karl H.), published 13 May 2003, discloses an aircraft seat with an energy-absorbing rectangular sheet of a stranded material which resists deformation when exposed to any force beyond a threshold. However, the performance of the energy-absorbing rectangular sheet depends mainly on the geometry of the seat structure, and it is limited in the amount of energy it can absorb.

U.S. Pat. No. 5,681,091 (Aircraft Modular Products, Inc.), published 28 Oct. 1997, discloses a seat pan in which the rear section is structured in a generally elevated position, such that a quantity of downward spine load will be absorbed at the connection at the rear edge and the rear cross support. However, the elevation angle requirements of the rear section require seat cushion modification, which greatly increases complexity as well as comfort.

The present invention seeks to solve and/or mitigate some or all of the above-mentioned problems. Alternatively and/or additionally, the present invention seeks to provide improved seat pans for aircraft seats, and improved aircraft seats.

### SUMMARY OF THE INVENTION

In accordance with a first aspect of the invention there is provided a seat pan for an aircraft seat, the seat pan being arranged to be fixed to an aircraft seat base and to support a seat cushion of the aircraft seat, wherein the seat pan comprises a corrugated portion formed of a deformable material, the corrugated portion comprising a plurality of corrugations.

By having a portion of the seat pan formed of a deformable material, i.e. of a material that can change shape without breaking, the seat pan is able to absorb energy due to the deformable material changing shape under vertical/longitudinal impact conditions, so reducing lumbar-column pelvic compressive load. Further, by having the portion that is formed of a deformable material be a corrugated portion comprising a plurality of corrugations, the corrugated portion is able to change shape without requiring other parts of the seat pan to do so as well. This includes in particular the outer edges of the seat pan, which can remain in place on the seat base despite the corrugated portion having been deformed. This means that the extent to which the corrugated portion is able to deform is not restricted, in particular as it would be if the corrugated portion changing shape required the material of it or other parts of the seat pan to be stretched. This is possible without requiring any of the other components of the aircraft seat having to be modified.

By corrugations is meant a plurality of ridges and grooves, or plications.

The deformable material may be plastically deformable. In other words, the deformable material may be permanently deformed when a force is applied, and not tend to return to its previous shape. Alternatively, the deformable material may be elastically deformable. The entirety of the seat pan may be formed of the deformable material, or only the corrugated portion.

The corrugated portion may be formed from metal sheet. The entirety of the seat pan may be formed of metal sheet, or only the corrugated region. The seat pan may consist of one contiguous metal sheet, or may consist of two or more separately-constructed parts that are fixed together. The corrugations may be formed by bending the metal sheet from which the corrugated portion is formed. The metal sheet may be aluminium. Other metals, or any other deformable materials, may be used, as long as they can be shaped into the required configuration. To give just some examples, the metal sheet may be an aluminium alloy, steel or stainless steel. The corrugated portion and/or the entire seat pan may not be formed from a sheet, and may, to give just one example, be 3D-printed in the required shape.

The seat pan may further comprise a planar portion. The seat pan may comprise multiple planar portions. Alternatively or additionally, the seat pan may comprise multiple corrugated portions.

The planar portion may be arranged to be positioned under a front part of the seat cushion, and the corrugated portion is arranged to be positioned further from the front part of the seat cushion than the planar portion. It will be understood that the front part of the seat cushion is the part at the front as considered from the perspective of an occupant sat in the aircraft seat facing forwards. The corrugated portion may be arranged to be positioned partly or completely under the rear part of the seat cushion, or may be arranged to be positioned entirely behind seat cushion, for example under a back cushion of the aircraft seat.

Where there are multiple planar portions, a second planar portion may be arranged to be positioned further from the front part of the seat cushion than the corrugated portion.

The planar portion and the corrugated portion may be constructed separately and fixed together to form the seat pan. This allows planar portion to be constructed relatively simply, with the more complicated constructed process for the corrugated portion, i.e. to create the corrugations being done separately. The planar portion and corrugated portion may be fixed together by riveting, welding, gluing or in any other suitable way. Alternatively, the entirety of the seat pan may be constructed as a single part.

The corrugations of the corrugated portion may extend from a first side to a second side of the seat pan, the first side and the second side extending between the front edge and back edge of the seat pan. Alternatively and/or additionally, the corrugated portion may extend from the front edge to the back edge of the seat pan, or between any other edges or combination of edges of the seat pan.

The longitudinal axis of each corrugation may be parallel to the front edge of the seat cushion when the seat cushion is in position on the seat pan. By longitudinal axis is meant the axis parallel to the folds that form the corrugations. The longitudinal axis of each corrugation may be as a consequence also be parallel to the front edge of the seat pan, but it may be that front of seat pan is angled with respect to the front edge of the seat cushion. Alternatively, the longitudinal axis of one or more corrugations may be at an angle to the front edge of the seat cushion. This includes the possibility that the longitudinal axis of one or more corrugations is perpendicular to the front edge of the seat cushion.

The corrugations may be parallel to each other. Alternatively, one or more corrugations may be at an angle with respect to each other. This includes the possibility that the one or more corrugations are perpendicular with respect to each other.

The distance between the adjacent vertically extending walls of adjacent corrugations may be the same or less than the distance between the vertically extending walls of each of the adjacent corrugations. By vertically extending it is meant that the walls extend over a vertical distance, but the walls themselves may be vertical, or may be at an angle to vertical.

In accordance with a second aspect of the invention there is provided an aircraft seat comprising a seat pan as described above. The aircraft seat may be an aircraft passenger seat.

It will of course be appreciated that features described in relation to one aspect of the present invention may be incorporated into other aspects of the present invention.

### DESCRIPTION OF THE DRAWINGS

Embodiments of the present invention will now be described by way of example only with reference to the accompanying schematic drawings of which:

FIG. 1 shows an aircraft seat in accordance with an embodiment of the invention;

FIG. 2 shows an aircraft seat pan in accordance with an embodiment of the invention;

FIG. 3 show the corrugated portion of the aircraft seat pan of FIG. 2;

FIG. 4 shows the corrugated portion of FIG. 3 following a vertical/longitudinal impact force having been applied to the corrugated portion;

FIG. 5 show a corrugated portion in accordance with another embodiment of the invention;

FIG. 6 show a corrugated portion in accordance with another embodiment of the invention;

FIG. 7 show a corrugated portion in accordance with another embodiment of the invention;

FIG. 8 show a corrugated portion in accordance with another embodiment of the invention;

FIG. 9 show an aircraft seat pan in accordance with another embodiment of the invention; and

FIG. 10 show an aircraft seat pan in accordance with another embodiment of the invention.

### DETAILED DESCRIPTION

Aircraft seat pans in accordance with an embodiments of the invention are now described.

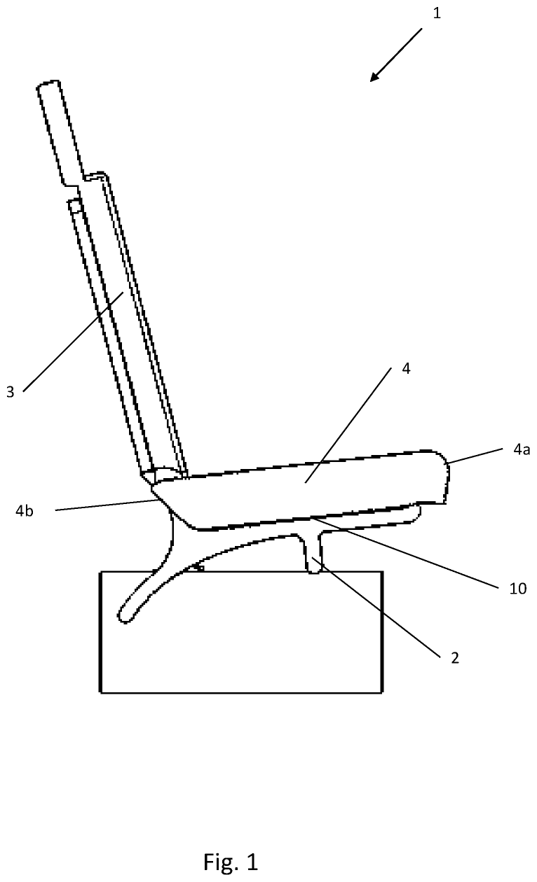

An aircraft seat is shown in FIG. 1. The aircraft seat 1 comprises a seat base 2, which is fixed to the floor of an aircraft cabin. Fixed to the upper side of the seat base 2 is a seat pan 10, as described in detail below. A seat cushion 4 is positioned on the seat pan 10, so that the seat pan 10 provides support for the seat cushion 4. The seat cushion 4 has a front end 4a, i.e. the end further forwards from the point of view of an occupant sitting in the aircraft seat 1, and a rear end 4b opposite the front end 4a. The aircraft seat 1 also comprises a cushioned back 3.

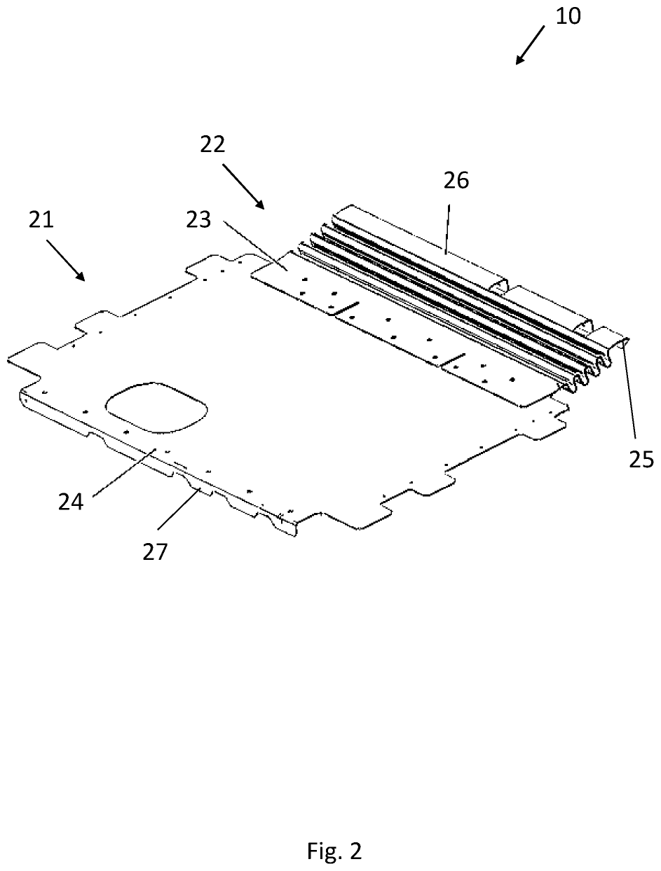

The seat pan 10, which is in accordance with an embodiment of the invention, is shown in FIG. 2. The seat pan 10 comprises a planar portion 21 and a corrugated portion 22. Each of the planar portion 21 and a corrugated portion 22 is formed from metal sheet, and the planar portion 21 and corrugated portion 22 are fixed together using tabs 23 of the corrugated portion 22. In the seat pan 10 the planar portion 21 and corrugated portion 22 are formed of aluminium and are riveted together, but in other embodiments different metals may be used, or other types of materials as long as they have the properties required for the invention. Similarly, the planar portion 21 and corrugated portion 22 may be fixed together in other ways, for example welded or glued, or the seat pan may be constructed as a single part.

The front end of 24 of the planar portion 21 is arranged to be positioned at the front of the aircraft seat 1, i.e. underneath the front end 4a of the seat cushion 4. The front end of 24 of the planar portion 21 has flanges 25, which hook over the edge of the seat base 2 to hold the seat pan 10 in position. Correspondingly, the rear end 26 of the corrugated portion 22 is arranged to be positioned at the rear of the aircraft seat 1, i.e. underneath the rear end 4b of the seat cushion 4, and has flanges 27 which hook over the opposite edge of the seat base 2 to again hold the seat pan 10 in position.

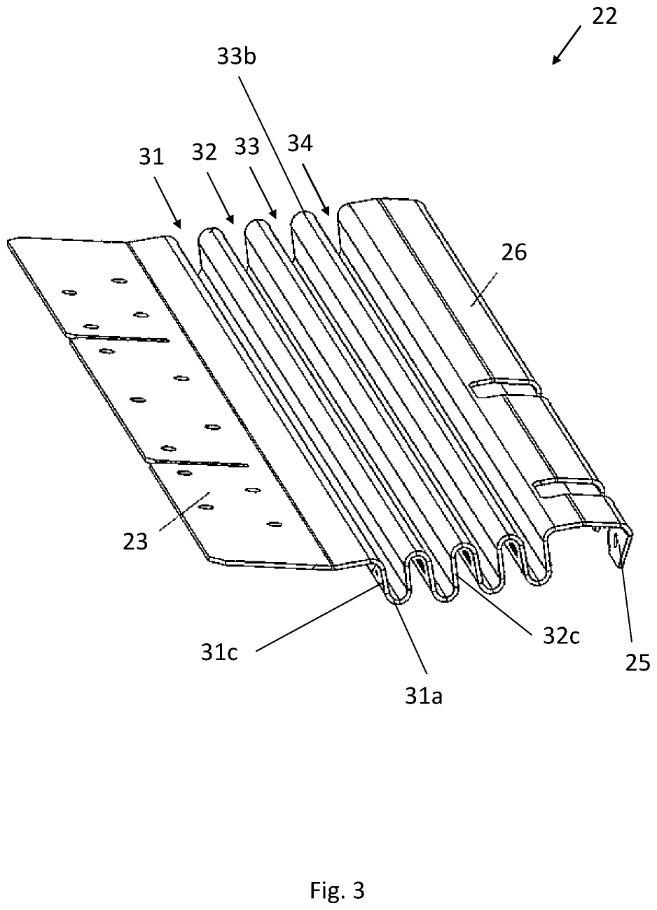

The corrugated portion 22 is shown in more detail in FIG. 3. As can be seen, the middle of the corrugated portion 22 has been folded to form four corrugations 31, 32, 33, 34. Each of the corrugations 31, 32, 33, 34 has a semi-circular base, for example the base 31a of corrugation 31, and between the corrugations 31, 32, 33, 34 are semi-circular tops, for example the top 33b between corrugation 33 and corrugation 34.

In the corrugated portion 22 each of the semi-circular bases of the corrugations 31, 32, 33, 34 has the same radius, and each top between the corrugations 31, 32, 33, 34 again has the same radius, which is in addition the same as the radius of each the semi-circular bases of the corrugations 31, 32, 33, 34. However, as discussed below, in other embodiments the bases and/or tops may have different radii and/or different shapes.

In the corrugated portion 22 the sides of each of the corrugations 32, 33, 34, for example the sides 32c of the corrugation 32, are of the same length. However, the sides 31c of the corrugation 31 are shorter than those of the corrugations 32, 33, 34. Thus, it can be seen that each of the corrugations 32, 33, 34 is of the same height, which the corrugation 31 is shorter. As discussed below, in other embodiments the corrugations may all be of the same height, or some or all may be of different heights.

In addition, in the corrugated portion 22 the sides of each of the corrugations 31, 32, 33, 34 are parallel. However, as discussed below, in other embodiments the sides of some or all of the corrugations may be angled, or may be shapes other than straight, for example curved.

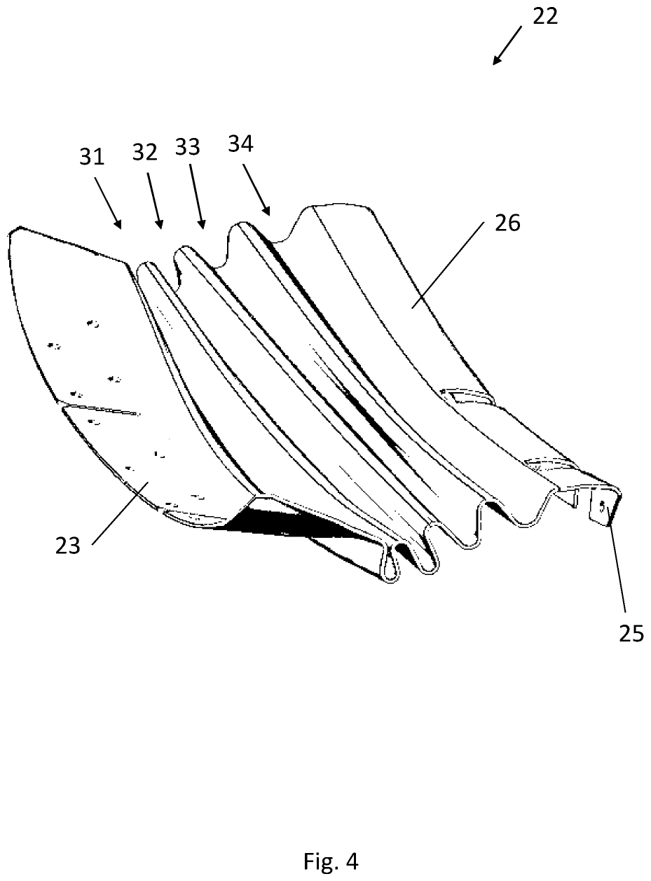

FIG. 4 shows the corrugated portion 22 of FIG. 3 following a vertical/longitudinal impact force having been applied to the corrugated portion 22 while part of a seat pan of an aircraft seat that has undergone a combined vertical/longitudinal impact test.

As can be seen, the corrugated portion 22, and particularly the corrugations 31, 32, 33, 34, have been permanently deformed. This has occurred as the material from which the corrugated portion 22 is formed, aluminium, is a plastically deformable material. The permanent deformation of the corrugated portion 22 has absorbed energy from the vertical/longitudinal impact force, so providing an increased the overall energy absorption of the seat structure resulting in reduction of the lumbar-column compressive forces of an occupant of the seat. While there has been some deformation of the edges of the corrugated portion 22, in particular the rear edge 26, this deformation was not necessary to allow the corrugations 31, 32, 33, 34 to deform, and so the deformation they have been able to undergo, and so the amount of energy they have been able to absorb, has not been restricted.

It will be appreciated that various modifications of the corrugated portion and seat pan are possible in accordance with the invention, and some exemplary alternative embodiments are now described. It will be appreciated that modifications of two or more of the different embodiments could be combined to give still further embodiments of the invention.

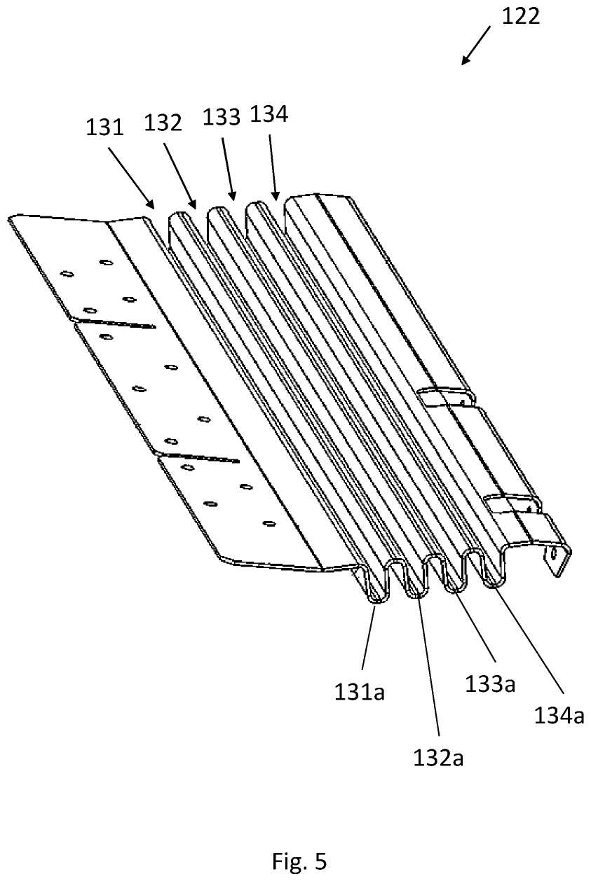

A corrugated portion 122 for a seat pan in accordance with another embodiment of the invention is shown in FIG. 5. In this embodiment, each of the corrugations 131, 132, 133, 134 of the corrugated portion 122 is of the same height, unlike the corrugations 31, 32, 33, 34 of the corrugated portion 22 of the previous embodiment. In addition, the bases 131a, 132a, 133a, 134a of the corrugations 131, 132, 133, 134, and also the tops between the corrugations 131, 132, 133, 134, are not semi-circular, but rather are formed of two 45° arcs with a flat part spacing between them.

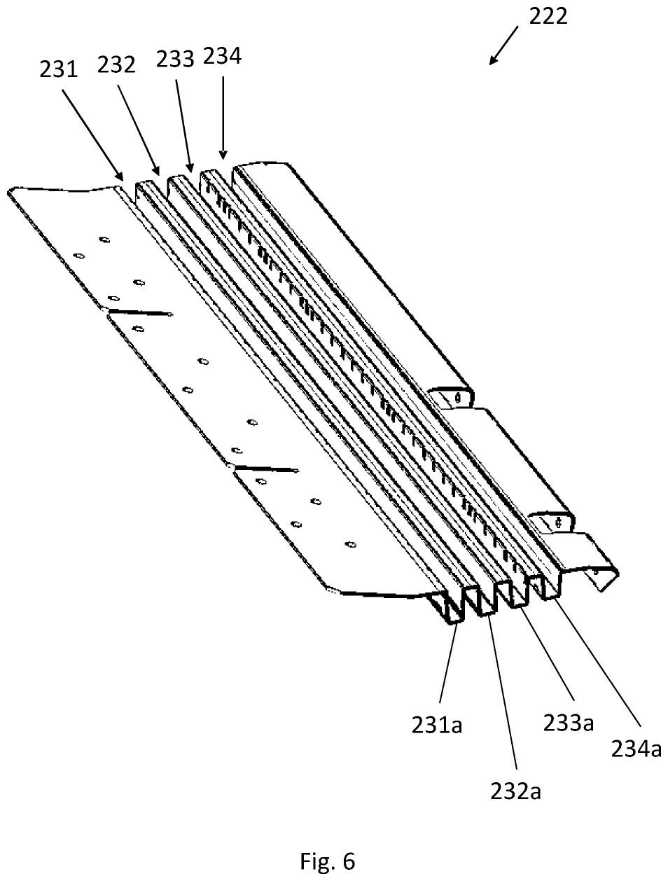

A corrugated portion 222 for a seat pan in accordance with another embodiment of the invention is shown in FIG. 6. As can be seen, the bases 231a, 232a, 233a, 234a of the corrugations 231, 232, 233, 234, and also the tops between the corrugations 231, 232, 233, 234, are flat rather than semi-circular.

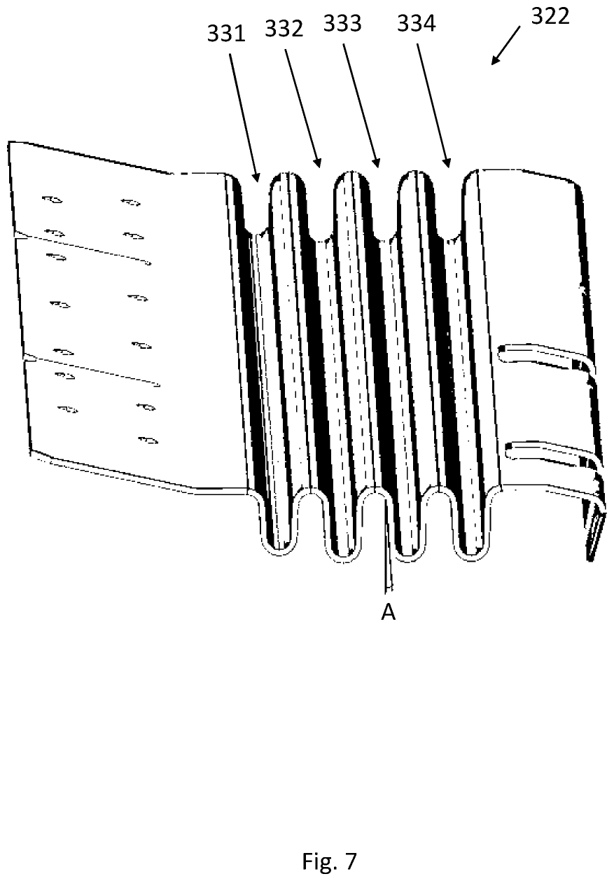

A corrugated portion 322 for a seat pan in accordance with another embodiment of the invention is shown in FIG. 7. In this embodiment, the sides of the corrugations 331, 332, 333, 334 are at an angle A to the vertical, rather than exactly vertical as in the previous embodiments.

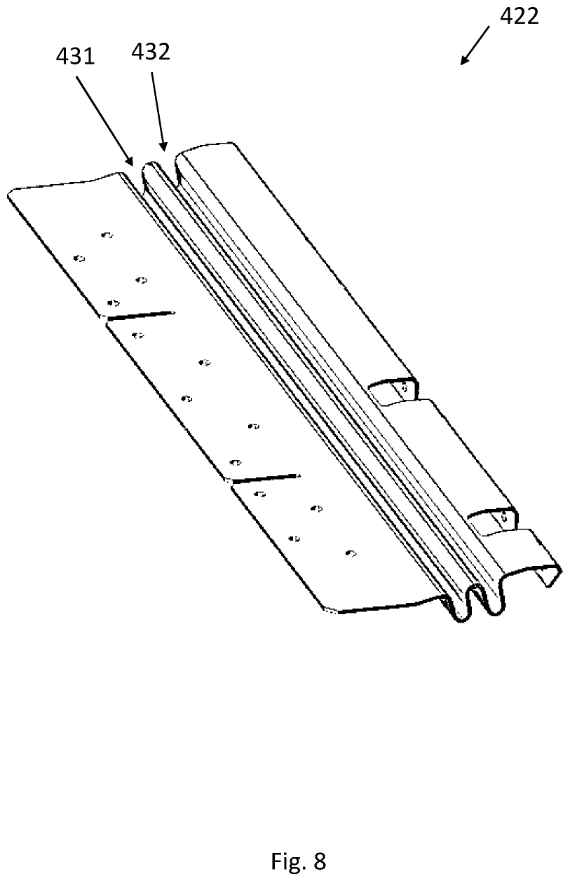

A corrugated portion 422 for a seat pan in accordance with another embodiment of the invention is shown in FIG. 8. In this embodiment, the corrugated portion 422 has only two corrugations 431, 432, rather than the four corrugations of the previous embodiments.

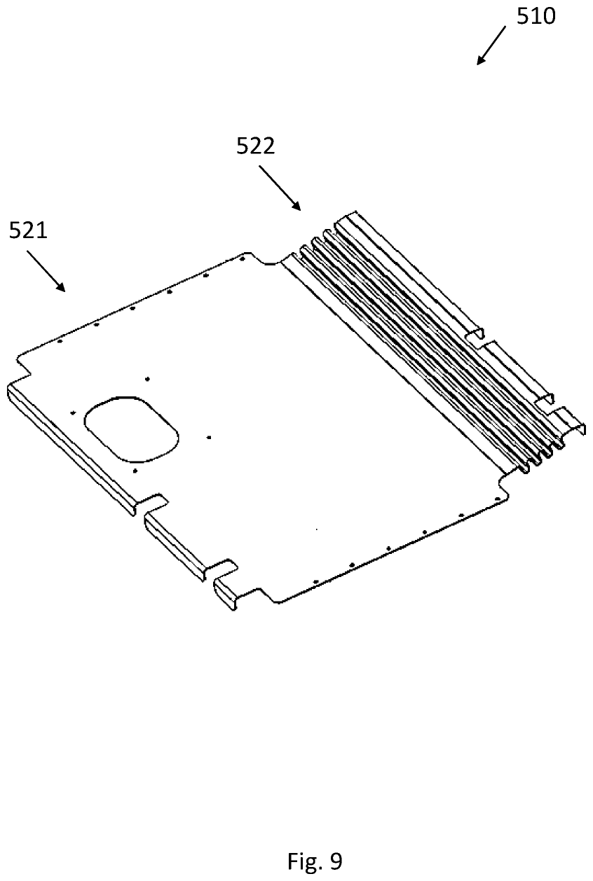

A seat pan 510 in accordance with another embodiment of the invention is shown in FIG. 9. In this embodiment, the planar portion 521 and corrugated portion 522 of the seat pan 510 are formed together from a single piece of metal sheet, rather than being formed separately and then fixed together.

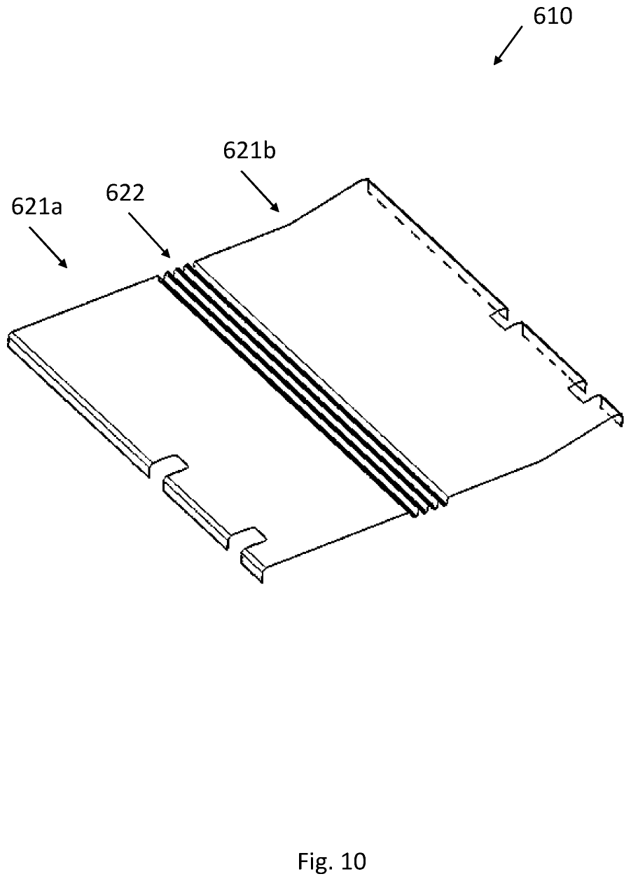

A seat pan 610 in accordance with another embodiment of the invention is shown in FIG. 10. In this embodiment, the seat pan 610 is comprised of a corrugated portion 622 positioned between a first planar portion 621a and a second planar portion 621b, so that the corrugated portion 622 is positioned roughly in the middle of the seat pan 610. In this embodiment the corrugated portion 622, first planar portion 621a and second planar portion 621b are formed together from a single piece of metal sheet, but it will be appreciated that in other embodiments they could be formed separately and then fixed together to form the seat pan.

While the present invention has been described and illustrated with reference to particular embodiments, it will be appreciated by those of ordinary skill in the art that the invention lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A seat pan for an aircraft seat, the seat pan being arranged to be fixed to an aircraft seat base and to support a seat cushion of the aircraft seat, wherein the seat pan comprises a corrugated portion formed of a deformable material, the corrugated portion comprising a plurality of corrugations.

2. A seat pan as claimed in claim 1, wherein the corrugated portion is formed from metal sheet.

3. A seat pan as claimed in claim 1, wherein the seat pan further comprises a planar portion.

4. A seat pan as claimed in claim 3, wherein the planar portion is arranged to be positioned under a front part of the seat cushion, and the corrugated portion is arranged to be positioned further from the front part of the seat cushion than the planar portion.

5. A seat pan as claimed in claim 3, wherein the planar portion and the corrugated portion are constructed separately and fixed together to form the seat pan.

6. A seat pan as claimed in claim 1, wherein the corrugations of the corrugated portion extend from a first side to a second side of the seat pan, the first side and the second side extending between the front edge and back edge of the seat pan.

7. A seat pan as claimed in claim 1, wherein the longitudinal axis of each corrugation is parallel to the front edge of the seat cushion when the seat cushion is in position on the seat pan.

8. A seat pan as claimed in claim 1, wherein corrugations are parallel to each other.

9. A seat pan as claimed in claim 1, wherein the distance between the adjacent vertically extending walls of adjacent corrugations is the same or less than the distance between the vertically extending walls of each of the adjacent corrugations.

10. An aircraft seat comprising a seat pan as claimed in claim 1.
